(19) United States
(12) Patent Application Publication
(10) Pub. No.: US 2004/0183265 A1
(43) Pub. Date: Sep. 23, 2004

(54) Smart cart beach chair

(76) Inventor: Brian Christopher Vecchio, Bel Air, MD (US)

Correspondence Address: Brian C. Vecchio, 708 TOBACCO RUN DR, BEL AIR, MD, 21015, US

(21) Appl. No.: 10/783,570

(22) Filed: Feb. 23, 2004

Related U.S. Application Data
(60) Provisional application No. 60/455,434, filed on Mar. 17, 2003.

(51) Int. Cl. B62B 1/00

(52) U.S. Cl. 280/47.18; 280/30

(57) ABSTRACT

A vehicle that is a two in one unique design. It is a cart (FIG. F) to transport beach items to the beach with the added convenience of converting into a comfortable chair (FIG. E) after arriving. Made of schedule 40 and 80 gauge PVC frame construction (FIG. D) it was designed for the beach resorts, for vacationers, to transport beach accessories with their families safely to the beaches and back. It tilts upward with a handle, that extends, to allow for pulling when in a standing position. Two sand tires allow movement across deep sand and rough terrain. Upon arriving cart is tilted downward which elevates tires and allows cart to sit on legs. Items are removed and when handle is retracted cart turns into a comfortable beach chair for relaxing. When leaving the handle again extends and accessories are loaded for the return trip from the beach.

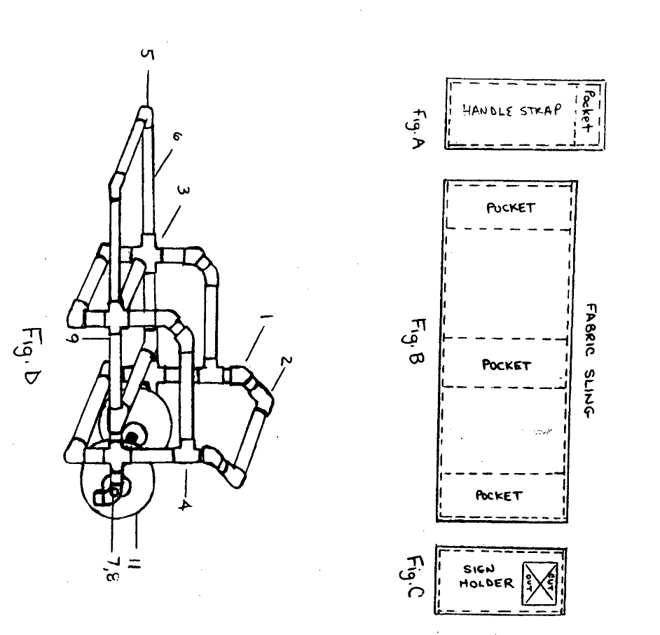

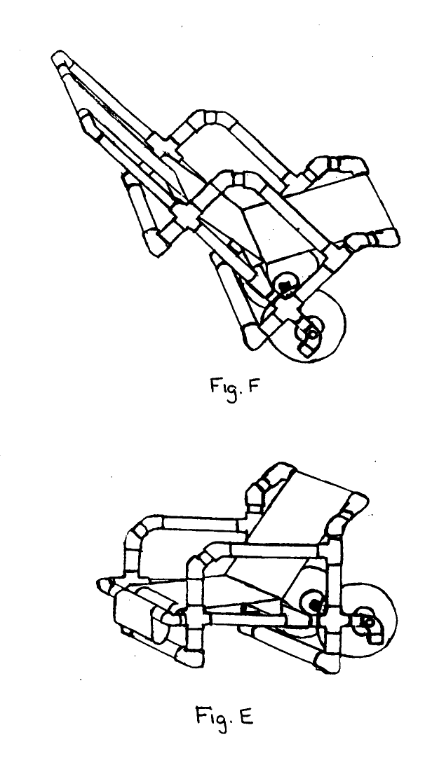

### CROSS REFERENCE TO RELATED APPLICATION

This application claims priority to provisional application 60/455434. Filed on Mar. 17, 2003. Titled “Smart Cart Beach Chair”.

### BACKGROUND OF THE INVENTION

This two in one invention relates to a pull cart to transport beach items to the beach easily and safely with the added convenience of converting into a comfortable seat after arriving.

### BRIEF SUMMARY OF THE INVENTION

Families have had the burden of carrying their beach items in their hands while trying to reach the beach safely with their children. Beach rental companies supply carts and chairs to vacationers at the beach areas but have not been able to supply one that can do both. With many of the beach accessories the wheels are unable to maneuver in the deep sand or rough terrain. There is one previously designed cart that is equipped with proper sand tires when at the beach, but it takes up space and ocean view from other people at the resort while not in use. The previously designed chairs with wheels have to be carried over the sand and rough terrain and any obstacles before getting to the beach. There are two chairs on the market with proper sand tires the first is a wheel chair equipped to transport handicapped people to the beach and the second is a lounge chair with large wheels they are rather cumbersome and are not equipped to carry items. Other carts designed to carry accessories have straps and hooks and potential dangers to small children. The proper sand tires as stated above are manufactured by Roleez and these items are advertised on their web site.

The Smart Cart Beach Chair is a two in one unique design, made of schedule 40 and 80 PVC frame construction. The retractable handle pulls out when cart is in use then retracts for sitting in a comfortable fabric chair. There are no straps or hooks or potential dangers. It is light weight and can be tilted upward for easy storage and is only the size of a normal sand chair. It was designed for the beach resorts, to be offered for rent by local hotels, motels, condos and business owners. The vacation renters at the resorts can rent the cart for easy access to the beach and back with their beach items and also be used as a relaxing chair after arriving at their destination. When their allotted rental time is over it will be returned to that business. It may also in the future be sold but not until written approval by the inventor has been warranted.

The Cart tilts upward and is pulled with a handle that extends for use, it rolls on two Roleez wheels and is designed to hold beach bags, sand toys, coolers, boogie boards, etc. but not limited to these items only. It can be maneuvered onto elevators through doorways into rooms and out with ease. Special wheels allow for easy movement in deep sand and rugged terrain. Frame structure will not bottom out when wheeled over curbs etc.

The Chair when in sitting position the wheels elevate off of the ground and chair sits on PVC legs. When accessories are unloaded, the handle retracts and you sit in a comfortable UV fabric that is strong and durable. It has two schedule 40 PVC arms and legs. It can sit on beaches or flat surfaces indoors or out. Optional cup, tray, umbrella and fishing rod holders can be attached to chair. Chair is designed to accommodate one person.

TABLE A
Material List See FIG. D

| Item | Qty | Description |
|---|---|---|
| 1 | 6 | 45 degree 1¼″ PVC elbows |
| 2 | 8 | 90 degree 1¼″ PVC elbows |
| 3 | 4 | + cross sections 1¼″ PVC |
| 4 | 6 | Tee 1¼″ PVC schedule 40 |
| 5 | 2 | 1″ PVC 90 degree schedule 80 elbows |
| 6 | 1 | 5 ft. of 1″ PVC schedule 80 for handle |
| 7 | 1 | ½″ axle |
| 8 | 2 | ½″ metal push caps with white plastic caps |
| 9 | 1 | 15 ft. of 1¼″ PVC schedule 40 |
| 10 | 10 | white aluminum # 8 screws various areas |
| 11 | 2 | 11.9″ Roleez Wheels |
| 12 | 1 | UV Fabric |

### BRIEF DESCRIPTION OF FIGURES AND TABLES OF THE DRAWINGS

In FIGS. A to F all dimensions are approximate.

FIG. A shows a fabric handle strap that attaches to sling and handle, which limits the handle extension.

FIG. B shows a three rod pocket UV fabric sling which holds beach items in cart and is used as a seat for chair.

FIG. C shows sign holder which attaches to back of sling with instructions for use of cart and chair.

FIG. D shows wheels, frame, extended handle and overall placement of enclosed material list (Table A)

FIG. E shows chair in sitting position.

FIG. F shows cart with extended handle.

In Table A is a material list.

### DETAILED DESCRIPTION OF THE INVENTION

The Smart Cart Beach Chair has a three rod pocket UV fabric sling in FIG. B that slides into place for holding beach items and also works together to assure a tight frame. Then after beach items are removed serves as a comfortable seat. On back of sling is a fabric sign holder in FIG. C with instructions for use of cart. A fabric handle strap in FIG. A that attaches to sling and handle limits the handle extension.

There are two 11.9 inch soft flexible pneumatic Roleez wheels that when handle is extended allow the cart to move over rough terrain. When cart is unloaded handle retracts and wheels lift off the ground and chair sits on PVC legs. Tires have a ½ inch arbor hole which receives an ½ inch axle which has been sprayed with extend to assure no rust. As shown in FIG. D.

The schedule 80 PVC handle extends which is limited by the length of the handle strap to allow pulling of cart. By pushing handle in the handle strap folds down to allow handle to retract to sit in chair. The schedule 80 PVC slides into schedule 40 PVC with very little tolerance which does not allow sand to bind up movement of handle. As shown in FIG. D.

All hardware is stainless steel/alloy. Weight is approximately 23 pounds. Overall approximate measurements are shown in FIG. D. Optional cup, tray, fishing rod and umbrella attachments are available.

I claim:

1. This vehicle is a two in one unique design that holds various items, which tilts upward and is pulled with a handle and rolls on two wheels, referred to as cart, upon arrival items are unloaded and vehicle sits on legs, and handle retracts for using as a comfortable seat, referred to as chair.
a. The vehicle of claim 1 wherein said cart is designed to hold beach accessories inside attached fabric, with handle that extends to allow for pulling when in a standing position causing said cart to tilt upward still allowing accessories to remain inside, then when walking the sand tires allow movement across deep sand and rough terrain with ease, upon arrival at destination accessories are removed.
b. The vehicle of claim 1 wherein said chair when tilted downward allows tires to elevate and it sits on attached legs, then retractable handle is pushed in to allow a person to sit onto attached fabric to make for a comfortable seat.
c. The vehicle of claim 1 wherein said handle extends which is limited by a strap allows pulling of said cart by pushing handle in the handle slides into the frame while strap folds down allowing handle to retract to sit in said chair.
